(19) United States
(12) Patent Application Publication
(10) Pub. No.: US 2019/0143417 A1
(43) Pub. Date: May 16, 2019

(54) MACHINE TOOL

(71) Applicant: OKUMA Corporation, Niwa-gun (JP)

(72) Inventor: Shoichi MORIMURA, Niwa-gun (JP)

(21) Appl. No.: 16/184,182

(22) Filed: Nov. 8, 2018

(30) Foreign Application Priority Data
Nov. 10, 2017 (JP) 2017-217159

(51) Int. Cl. B23B 25/02; B23B 31/10

(52) U.S. Cl. CPC B23B 25/02; B23B 31/10

(57) ABSTRACT

A machine tool for cutting swarf entangled with a tool. A chuck is attached to a spindle of the machine tool, and grips a workpiece. The chuck is constituted by a first sub chuck and a second sub chuck detachably attached to the first sub chuck. The second sub chuck provided with a cutting tool is attached to the first sub chuck, and the cutting tool is caused to perform an opening/closing operation using a drive force of an opening/closing drive mechanism for gripping/releasing the workpiece, thereby cutting swarf entangled with a turning tool into fragments.

### CROSS REFERENCE TO RELATED APPLICATION

The present application claims priority under 35 U.S.C. § 119 to Japanese Patent Application No. 2017-217159 filed on Nov. 10, 2017 including the specification, claims, drawings, and abstract is incorporated herein by reference in its entirety.

### TECHNICAL FIELD

The present disclosure relates to a machine tool.

### BACKGROUND

A machine tool for performing removal machining on a workpiece with a tool is conventionally known. In this type of machine tool, although demands for automation and high performance are increasing more and more, as a factor hindering the automation, there is a problem that swarf is entangled with a tool of the machine tool.

JP 2010-52102 A discloses an NC processing machine in which there is no possibility of interference between a swarf cutter and the like with a tool, a workpiece, or the like at the time of processing, and further facility expense can be suppressed lower. The NC processing machine includes a tool post freely movable in both the Z-axis direction and the X-axis direction, a turret rotatably supported on the tool post so as to be rotatable around a T-axis, a plurality of tool holders attached to an outer circumferential surface of the turret, and a swarf processing member disposed in such a way as to advance and retract with respect to a processing position in a movement path along which the tool moves at least in either one of the Z-axis direction and the X-axis direction of the tool post.

The entanglement of swarf with a machine tool often occurs when the swarf is continuously generated in lathe turning or the like. Therefore, it is necessary to cut the continuous swarf into fragments.

In general, a machine tool is provided with a rotary part, and bringing a rotating tool into contact with the swarf is relatively easy. However, since the position of the swarf is not fixed, even when the rotating tool comes into contact with the swarf, the swarf often move away from the rotating tool. In view of this, a pinching and cutting function such as a nipper or the like is desired.

Therefore, it is conceivable to use a robot or the like to cut the swarf with a nipper-like cutter. However, in many cases, metal swarf generated during the lathe turning is relatively hard, and accordingly a large force is required for a cutting tool. For this reason, an actuator, a drive mechanism, or the like tends to increase in size, and as a result, costs increase. Further, the size of the robot itself for driving a cutter such as a nipper tends to increase, and inconveniences such as interference with another member or the like may arise.

### SUMMARY

The present disclosure provides a technique capable of cutting swarf entangled with a tool without adding an actuator or a drive mechanism larger in size.

The present disclosure is a machine tool including a rotating device for rotating a workpiece, a chuck provided at the rotating device and including an opening/closing drive mechanism for gripping and releasing the workpiece, a moving mechanism for adjusting a relative positional relationship between the workpiece and a turning tool for lathing the workpiece, and an attaching device for causing the opening/closing drive mechanism and a swarf cutting tool to engage with each other by attaching the swarf cutting tool to the chuck in a state where the workpiece is not gripped, and for cutting the swarf entangled with the turning tool by driving the swarf cutting tool with an opening/closing operation of the opening/closing drive mechanism.

According to one embodiment of the present disclosure, the attaching device is a robot or a loader.

According to another embodiment of the present disclosure, the robot is provided in the machine tool.

Further, according to another embodiment of the present disclosure, the chuck is constituted by a first sub chuck provided at the rotating device, and a second sub chuck provided so as to be attachable to and detachable from the first sub chuck. The second sub chuck is equipped with the swarf cutting tool, and the attaching device causes the swarf cutting tool to engage with the opening/closing drive mechanism by attaching the second sub chuck to the first sub chuck.

Further, according to another embodiment of the present disclosure, the chuck includes a plurality of claws opened or closed according to the opening/closing operation of the opening/closing drive mechanism, and the attaching device causes the swarf cutting tool to engage with the opening/closing drive mechanism by attaching the cutting tool to the claw.

Further, according to another embodiment of the present disclosure, the chuck includes a plurality of detachable claws opened or closed according to the opening/closing operation of the opening/closing drive mechanism, and the attaching device causes the swarf cutting tool to engage with the opening/closing drive mechanism by detaching the claw from the chuck and attaching the cutting tool.

Further, according to another embodiment of the present disclosure, the chuck includes a plurality of claws opened or closed according to the opening/closing operation of the opening/closing drive mechanism, and the attaching device causes the swarf cutting tool to engage with the opening/closing drive mechanism by causing a part of the cutting tool to engage with the claw while gripping the cutting tool.

Further, according to another embodiment of the present disclosure, the cutting tool is constituted by a first cutting tool and a second cutting tool that are paired, and is configured to cut the swarf by performing an opening/closing operation in the same direction as the direction of the opening/closing operation of the opening/closing drive mechanism.

Further, according to another embodiment of the present disclosure, the cutting tool is constituted by a first cutting tool and a second cutting tool that are paired, and is configured to cut the swarf by performing an opening/closing operation in a direction different from the direction of the opening/closing operation of the opening/closing drive mechanism.

Further, according to another embodiment of the present disclosure, the cutting tool cuts the swarf on a rotational axis of the rotating device.

Further, according to another embodiment of the present disclosure, the cutting tool cuts the swarf at a position offset by a predetermined distance from the rotational axis of the rotating device.

Further, according to another embodiment of the present disclosure, a sensor for detecting the swarf entangled with the turning tool is provided, and the attaching device attaches the cutting tool according to a detection signal of the sensor.

According to the present disclosure, it is possible to cut the swarf entangled with a tool without adding an actuator or a drive mechanism larger in size. As a result, machine stop due to the entanglement of the swarf can be suppressed and the level of automation of the machine tool can be improved.

### BRIEF DESCRIPTION OF DRAWINGS

Embodiment(s) of the present disclosure will be described by reference to the following figures, wherein:

FIG. 1 is a perspective view illustrating a machine tool;

FIG. 2 is an explanatory view illustrating exemplary replacement of claws (jaws) of a chuck performed by an in-machine robot;

FIG. 3A and FIG. 3B are explanatory views illustrating exemplary installation of cutting tools performed by the in-machine robot (part 1);

FIG. 4 is an explanatory view illustrating exemplary installation of cutting tools performed by the in-machine robot (part 2);

FIG. 5 is an explanatory view illustrating exemplary installation of cutting tools performed by the in-machine robot (part 3);

FIG. 6 is an explanatory view illustrating exemplary installation of cutting tools performed by the in-machine robot (part 4);

FIG. 7 is an explanatory view illustrating exemplary installation of cutting tools performed by the in-machine robot (part 5);

FIG. 8 is an explanatory view illustrating exemplary installation of cutting tools performed by the in-machine robot (part 6); and

FIG. 9 is an explanatory view illustrating exemplary installation of cutting tools performed by the in-machine robot (part 7).

### DESCRIPTION OF EMBODIMENTS

Hereinafter, embodiments of the present disclosure will be described with reference to attached drawings.

### First Embodiment

FIG. 1 illustrates a schematic configuration of a machine tool 10. In the following description, a rotational axis direction of a spindle device 14 is referred to as Z axis, a moving direction of a tool post 4 orthogonal to the Z axis is referred to as X axis, and a direction orthogonal to the Z axis and the X axis is referred to as Y axis.

The machine tool 10 is a machine configured to cut a workpiece with a tool. More specifically, the machine tool 10 has a lathing function of cutting a workpiece 3 with an applied turning tool while rotating the workpiece 3, and a rotary cutting function of cutting the workpiece 3 with a rotating tool.

The periphery of the machine tool 10 is covered with a cover (not illustrated). The space comparted by the cover is a machining chamber in which the workpiece 3 is machined. By providing the cover, scattering of swarf and the like to the outside can be prevented. The cover is provided with at least one aperture (not illustrated) and a door (not illustrated) for opening and closing the aperture. An operator accesses the inside of the machine tool 10, the workpiece 3, and the like via the aperture opening. During the machining, the door provided at the aperture is closed. This is to ensure safety, environmental friendliness, and the like.

The machine tool 10 includes the spindle device 14 for rotatably holding the workpiece 3 and the tool post 4 for holding a tool 100. The spindle device 14 includes a head stock placed on a base 22 and a workpiece spindle attached to the head stock. The workpiece spindle includes a chuck for grippably and releasably holding the workpiece 3, and can appropriately replace the gripped workpiece 3. In the drawings, a configuration capable of gripping and releasing the workpiece 3 by opening and closing three claws provided at the chuck is exemplarily illustrated. However, the number of the claws is arbitrary. Another configuration for gripping and releasing the workpiece 3 by opening and closing two claws provided at mutually opposing positions may be provided. The workpiece spindle rotates around a workpiece rotational axis extending in the horizontal direction (Z-axis direction).

The tool post 4 holds the turning tool; for example, a tool referred to as a bite. The tool post 4 and the bite are configured to be linearly movable in the X-axis and Z-axis directions when driven by a drive mechanism.

A discharge mechanism for collecting and discharging the swarf scattered during the cutting processing is provided at the bottom of the machining chamber. It is conceivable that the discharge mechanism can be constituted in various forms. For example, the discharge mechanism may be constituted by a conveyor or the like capable of conveying to the outside the swarf dropped due to gravity.

The machine tool 10 includes a controller that performs various calculations. The controller in the machine tool 10 is also referred to as a numerical controller (NC), which controls driving of each portion of the machine tool 10 in response to an instruction from an operator. The controller is, for example, constituted by a central processing unit (CPU) performing various calculations, a memory storing various control programs and control parameters, an input/output interface, an input device, and an output device. The input device is, for example, a touch panel or a keyboard. The output device is a liquid crystal display, an organic EL display, or the like. Both the input device and the output device may be constituted by a touch panel. Further, the controller has a communication function and can transmit and receive various data, such as NC program data, to and from other apparatuses. For example, the controller may include a numerical controller for calculating the positions of the tool 100 and the workpiece at any time. The controller may be a single device or may be constituted as a combination of a plurality of calculation devices.

The machine tool 10 further includes an in-machine robot 20. The in-machine robot 20 includes joints, knots, and a hand.

In the present embodiment, a robot disposed at a predetermined position in the machining chamber is referred to as the in-machine robot. The predetermined position does not necessarily means a stationary position and shall include, in the concept thereof, a movable position that can shift to a desired position during the machining of a workpiece or the like, even when it is fixed to at a certain position in the initial state.

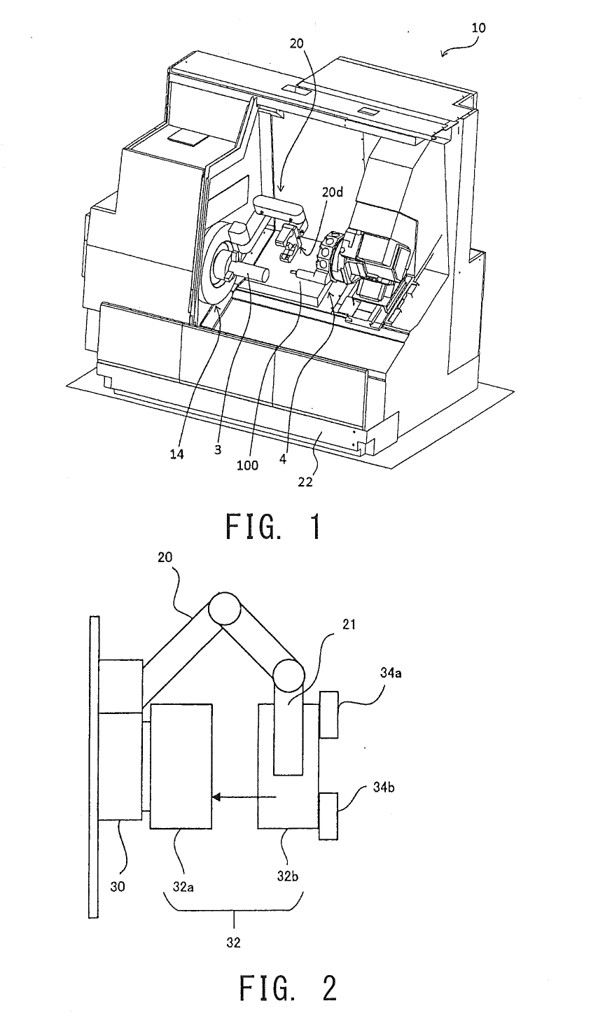

FIG. 2 illustrates the configuration of a spindle 30 attached to the spindle device 14 and a chuck 32 attached to the spindle.

The spindle 30 is attached to the spindle device 14, and the chuck 32 is attached to the spindle 30. The chuck 32 is constituted by a first sub chuck 32a and a second sub chuck 32b. The first sub chuck 32a and the second sub chuck 32b are detachably constituted. The second sub chuck 32b includes claws (jaws) 34a and 34b formed on a surface opposite to a surface facing the first sub chuck 32a so as to grip the workpiece 3. The claws 34a and 34b are provided with soft claws and master jaws to which the soft claws are fixed by means of bolts. The master jaws include rack gears that can mesh with a drive mechanism of the first sub chuck 32a in a state where the first sub chuck 32a and the second sub chuck 32b are in contact with each other.

More specifically, for example, the first sub chuck 32a includes a hydraulic cylinder together with a piston and a piston rod that are fitted into the cylinder. Rack gears are engraved at a tip end of the piston rod, so that a pair of pinion gears can mesh with the rack gears. Rack gears are engraved on rear end surfaces of a pair of master jaws formed with the claws 34a and 34b at tip ends thereof. The rack gears of the master jaws are configured to mesh with the pinion gears of the first sub chuck 32a. When the piston advances under hydraulic pressure, the claws 34a and 34b are closed and grip the workpiece 3. When the piston retracts, the claws 34a and 34b are opened and release the workpiece 3.

A hand 21, which is attached at a distal end of the in-machine robot 20, grips the second sub chuck 32b equipped with the claws 34a and 34b and causes the second sub chuck 32b to move to a desired position to bring one surface of the second sub chuck 32b into contact with the first sub chuck 32a, thereby causing the rack gears of the pair of master jaws of the claws 34a and 34b to mesh with the drive mechanism of the first sub chuck 32a. The first sub chuck 32a and the second sub chuck 32b are fixed by means of bolts. Further, when replacing the claws 34a and 34b, the in-machine robot 20 releases the meshing state between the pair of master jaws and the drive mechanism of the first sub chuck 32a, grips the second sub chuck 32b, and detaches it from the first sub chuck 32a.

In the present embodiment, using such a mechanism for replacing the claws (jaws) 34a and 34b by the in-machine robot 20, a swarf cutting tool is attached to the chuck 32 in place of the claws 34a and 34b, and a large force is applied to the cutting tool using the opening/closing drive mechanism of the chuck 32 to enable cutting of hard swarf such as metal swarf.

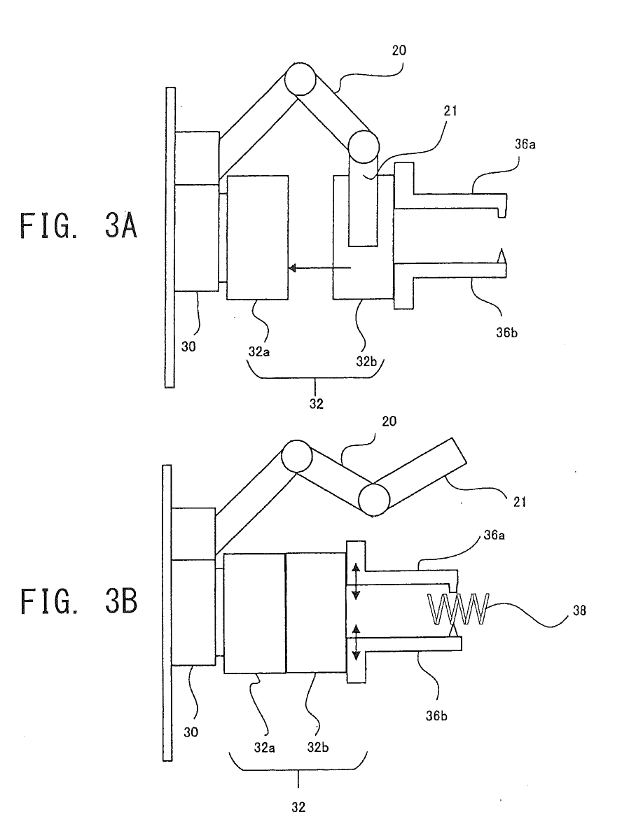

FIG. 3A and FIG. 3B illustrate exemplary states of cutting tools installed by the in-machine robot 20.

As illustrated in FIG. 3A, in a state where the second sub chuck 32b is detached from the first sub chuck 32a, the hand 21 of the in-machine robot 20 grips the second sub chuck 32b having a pair of cutting tools (a first cutting tool and a second cutting tool) 36a and 36b formed on a tip surface thereof in place of the second sub chuck 32b having the claws 34a and 34b formed on a tip surface thereof. The cutting tools 36a and 36b function as a stopper and a blade that are paired, and extend in a direction perpendicular to the paper surface. Similar to the claws 34a and 34b, the pair of cutting tools 36a and 36b includes a pair of master jaws fixed by means of bolts. The rack gears that can mesh with the drive mechanism of the first sub chuck 32a are engraved on the rear end surfaces of the master jaws.

The hand 21 of the in-machine robot 20 grips the second sub chuck 32b and moves the second sub chuck 32b so as to come into contact with the first sub chuck 32a, thereby causing the rack gears of the pair of master jaws to mesh with the drive mechanism of the first sub chuck 32a.

FIG. 3B illustrates a state where the second sub chuck 32b has been attached to the first sub chuck 32a. The turning tool is moved in a direction approaching close to the pair of cutting tools 36a and 36b, so that swarf 38 entangled with the turning tool is positioned between the cutting tools 36a and 36b. Then, the opening/closing drive mechanism of the first sub chuck 32a causes the pair of cutting tools 36a and 36b to perform an opening/closing operation in arrow directions illustrated in the drawing. The pair of opposing cutting tools 36a and 36b pinches the swarf 38 from both sides thereof and cuts (shears) it into fragments desirable in size.

### Second Embodiment

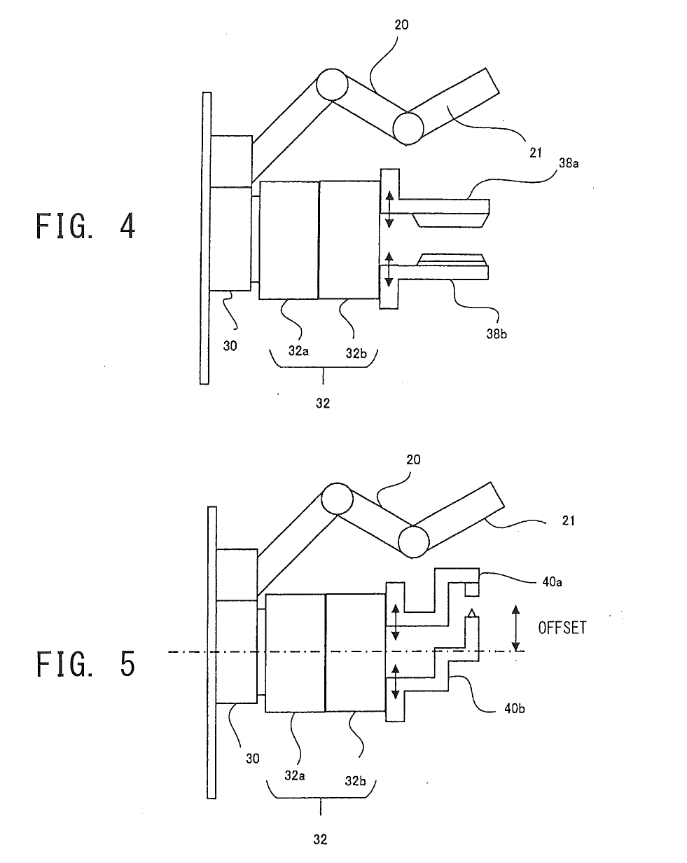

FIG. 4 illustrates another state of cutting tools installed by the in-machine robot 20. Similar to FIG. 3A and FIG. 3B, in a state where the second sub chuck 32b is attached to the first sub chuck 32a, the hand 21 of the in-machine robot 20 grips the second sub chuck 32b formed with a pair of cutting tools 38a and 38b in place of the second sub chuck 32b formed with the claws 34a and 34b. The cutting tools 38a and 38b function as a stopper and a blade that are paired, and extend in a direction horizontal to a rotational axis direction (Z direction) of the spindle 30. Similar to the claws 34a and 34b, the pair of cutting tools 38a and 38b includes a pair of master jaws fixed by means of bolts. The master jaws include rack gears that can mesh with the drive mechanism of the first sub chuck 32a.

The hand 21 of the in-machine robot 20 grips the second sub chuck 32b and moves the second sub chuck 32b so as to come into contact with the first sub chuck 32a, thereby causing the rack gears of the pair of master jaws to mesh with the opening/closing drive mechanism of the first sub chuck 32a. The opening/closing drive mechanism of the first sub chuck 32a causes the pair of cutting tools 38a and 38b to perform an opening/closing operation in arrow directions illustrated in the drawing. The pair of cutting tools 38a and 38b pinches the swarf 38 from both sides thereof and cuts it into fragments of desirable size.

### Third Embodiment

In FIG. 3A, FIG. 3B, and FIG. 4, the pair of cutting tools 36a and 36b or the pair of cutting tools 38a and 38b is configured to come into contact with each other to cut (shear) the swarf 38 on the rotation center axis of the spindle 30. Alternatively, as illustrated in FIG. 5, a pair of bent cutting tools 40a and 40b may be configured to cut (shear) the swarf 38 at a position offset by a predetermined distance from the rotation center axis of the spindle 30 in the X-axis direction.

### Fourth Embodiment

In FIG. 3A and FIG. 3B to FIG. 5, the opening/closing direction of the claws 34a and 34b agrees with the opening/closing direction of the pair of cutting tools 36a and 36b, 38a and 38b, or 40a and 40b. However, the opening/closing direction of the claws 34a and 34b may be configured to be different from the opening/closing direction of the cutting tools.

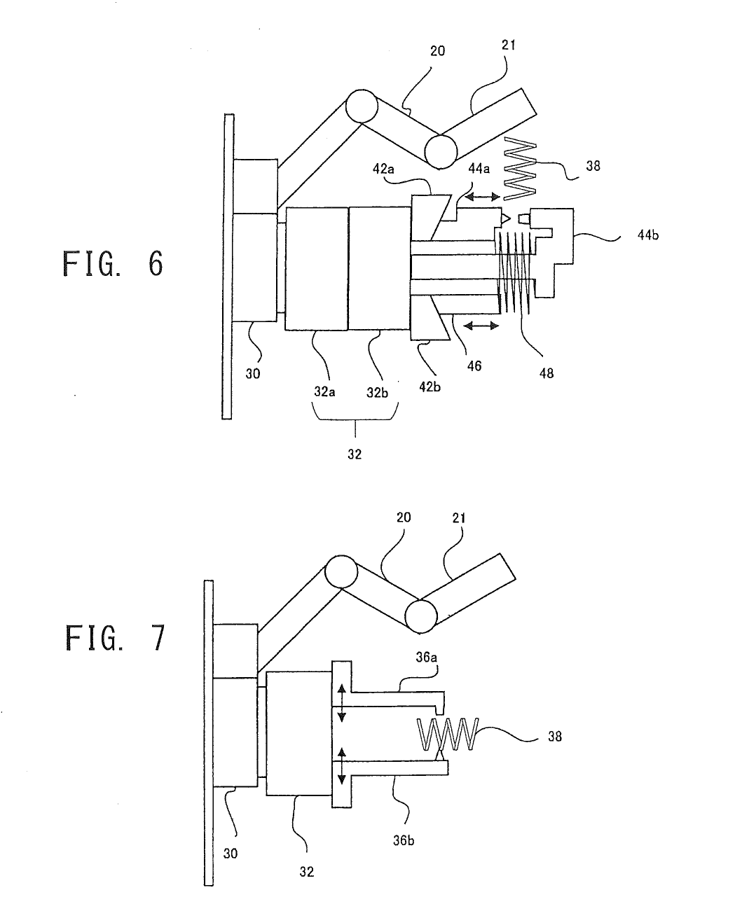

FIG. 6 illustrates still another state of cutting tools installed by the in-machine robot 20.

Similar to FIG. 3A and FIG. 3B, in a state where the second sub chuck 32b is attached to the first sub chuck 32a, the hand 21 of the in-machine robot 20 grips the second sub chuck 32b formed with a pair of cams 42a and 42b and a pair of cutting tools 44a and 44b in place of the second sub chuck 32b formed with the claws 34a and 34b. The cutting tools 44a and 44b function as a stopper and a blade that are paired. The cutting tool 44a extends in the rotational axis direction (Z-axis direction) of the spindle 30, and has an inclined surface formed on a rear end surface thereof that comes into contact with the cam 42a. The cams 42a and 42b are provided at the positions of the claws 34a and 34b in FIG. 2 and driven by the opening/closing drive mechanism to perform an opening/closing operation. Further, the cutting tool 44b extends in the rotational axis direction (Z-axis direction) on the rotation center axis of the spindle 30, and has a tip end bent in a “U-like” shape. A blade formed at the tip end is opposed to the cutting tool 44a. A spring 48 is wound around the cutting tool 44b. The spring 48 engages with the shoulder of the cutting tool 44a, and the tip end of an engaging member 46 formed at a position opposing the cutting tool 44a with the cutting tool 44b interposed therebetween. Similar to the cutting tool 44a, an inclined surface is formed on a rear end of the engaging member 46 that comes into contact with the cam 42b. Similar to the claws 34a and 34b, the cams 42a and 42b include a pair of master jaws fixed by means of bolts. The master jaws include rack gears that can mesh with the drive mechanism of the first sub chuck 32a.

The hand 21 of the in-machine robot 20 grips the second sub chuck 32b and moves the second sub chuck 32b so as to come into contact with the first sub chuck 32a, thereby causing the rack gears of the pair of master jaws to mesh with the drive mechanism of the first sub chuck 32a. When the drive mechanism of the first sub chuck 32a moves the cams 42a and 42b in a closing direction, the cutting tool 44a and the engaging member 46 move in the Z-axis direction against the elastic force of the spring 48 so as to cause the pair of opposed cutting tools 44a and 44b to perform a closing operation to pinch and cut the swarf 38 from both sides thereof. When the cams 42a and 42b are moved in an opening direction, the cutting tool 44a and the engaging member 46 return the original positions by the elastic force of the spring 48 (opening operation).

### Fifth Embodiment

In FIG. 3A and FIG. 3B to 6, the second sub chuck 32b including the cutting tools is attached to the first sub chuck 32a and the drive force of the first sub chuck 32a is used. However, the claws 34a and 34b themselves of the chuck 32 may be detachably configured so that the claws 34a and 34b can be replaced with the cutting tools.

FIG. 7 illustrates yet another state of cutting tools installed by the in-machine robot 20. The chuck 32 is not separated into the first sub chuck 32a and the second sub chuck 32b and is integrally formed. The claws 34a and 34b are detachably provided on a tip surface of the chuck 32. The hand 21 of the in-machine robot 20 grips the claws 34a and 34b and detaches them from the chuck 32, and then installs a pair of cutting tools 36a and 36b on the chuck 32. Similar to the claws 34a and 34b, the pair of cutting tools 36a and 36b includes a pair of master jaws fixed by means of bolts. The master jaws include rack gears that can mesh with the drive mechanism of the chuck 32. The opening/closing drive mechanism of the chuck 32 causes the pair of cutting tools 36a and 36b to perform an opening/closing operation. The pair of cutting tools 36a and 36b pinches and cuts the swarf 38 from both sides thereof.

### Sixth Embodiment

Although the cutting tools 36a and 36b are attached to the chuck 32 in place of the claws 34a and 34b in FIG. 7, the cutting tools 36a and 36b may be attached to the claws 34a and 34b themselves.

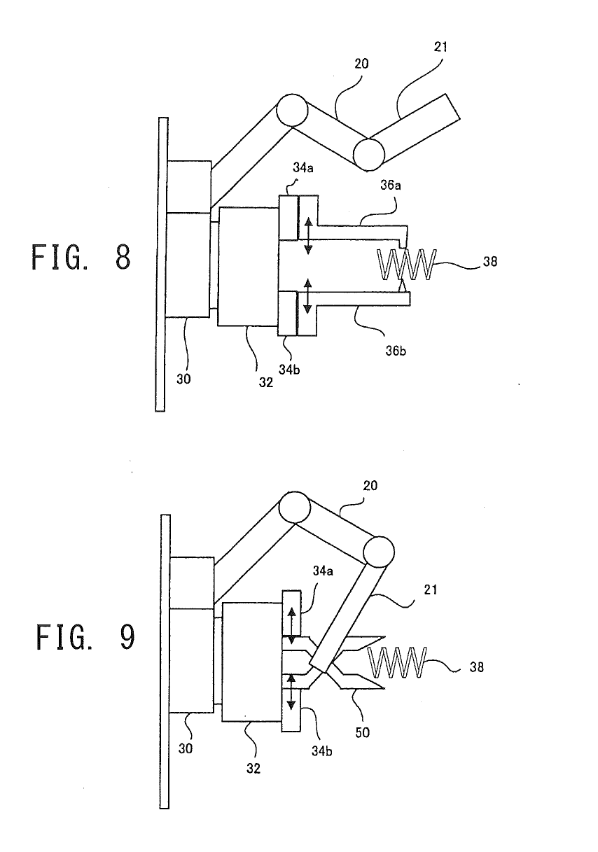

FIG. 8 illustrates still another state of cutting tools installed by the in-machine robot 20. The chuck 32 is not separated into the first sub chuck 32a and the second sub chuck 32b and is integrally formed. The claws 34a and 34b are provided on the tip surface of the chuck 32. The hand 21 of the in-machine robot 20 grips the cutting tools 36a and 36b and attaches them to tip surfaces of the claws 34a and 34b. The claws 34a and 34b include a pair of master jaws fixed by means of bolts. The master jaws include rack gears that can mesh with the opening/closing drive mechanism of the chuck 32. The opening/closing drive mechanism of the chuck 32 causes the claws 34a and 34b to perform an opening/closing operation and correspondingly causes the pair of cutting tools 36a and 36b to perform an opening/closing operation. The pair of cutting tools 36a and 36b pinches and cuts the swarf 38 from both sides thereof.

### Seventh Embodiment

Although the cutting tools 36a and 36b are attached to the tip surfaces of the claws 34a and 34b in FIG. 8, instead of installing the cutting tools on the claws 34a and 34b, the cutting tools may be configured to function using the opening/closing operation of the claws 34a and 34b, by causing a part of the cutting tools to engage with the claws 34a and 34b while gripping and holding the cutting tools by the hand 21 of the in-machine robot 20.

FIG. 9 illustrates yet another state of cutting tools installed by the in-machine robot. The hand 21 of the in-machine robot 20 grips a fulcrum point of a cutting tool 50 such as a nipper and causes rear ends of handles to come into contact and engage with inner peripheral side surfaces of the claws 34a and 34b. The opening/closing drive mechanism of the chuck 32 causes the claws 34a and 34b to perform an opening/closing operation. Correspondingly, blades of the cutting tool 50 gripped by the hand 21 perform an opening/closing operation and pinch and cut the swarf 38 from both sides thereof.

In FIG. 9, the cutting tool 50 is configured to perform the closing operation by the closing operation of the claws 34a and 34b. To the contrary, the cutting tool 50 may be configured to perform the closing operation by the opening operation of the claws 34a and 34b.

As mentioned above, according to these embodiments, it is possible to surely cut the swarf entangled with the turning tool into fragments using the opening/closing drive force of the spindle device 14, without newly adding an actuator or a drive mechanism larger in size. As a result, the machine stop due to the entanglement of the swarf can be suppressed and the automation efficiency of the machine tool can be improved.

In each of the above-mentioned embodiments, in a state where the chuck 32 does not grip the workpiece 3, the cutting tools are attached to the chuck 32 by the in-machine robot 20. However, the cutting tools may be attached by a robot located outside and disposed in the vicinity of the machine tool, or may be attached by a conveyance apparatus such as a loader.

Further, in each of the above-mentioned embodiments, a sensor for detecting whether there is any swarf entangled with the turning tool may be provided at a predetermined position in the machining chamber. The cutting tools may be attached to the chuck 32 by the in-machine robot 20 in response to detection of any entanglement of the swarf by the sensor as a trigger. It is desirable to install the sensor in the in-machine robot 20 and detect the entanglement of the swarf by monitoring the turning tool at an arbitrary position and from an arbitrary direction. Further, it is useful to detect the entanglement position and the entanglement state of the swarf with the sensor and adaptively change the type or the installation position of the cutting tools according to the detection result. Since the cutting tools are attached to the chuck 32 and the spindle 30 can rotate the chuck 32, the cutting surface by the cutting tools can be arbitrarily indexed.

1. A machine tool comprising:
a rotating device for rotating a workpiece;
a chuck provided at the rotating device and including an opening/closing drive mechanism for gripping and releasing the workpiece;
a moving mechanism for adjusting a relative positional relationship between the workpiece and a turning tool for lathing the workpiece; and
an attaching device for causing the opening/closing drive mechanism and a swarf cutting tool to engage with each other by attaching the swarf cutting tool to the chuck in a state where the workpiece is not gripped, and for cutting swarf entangled with the turning tool by driving the swarf cutting tool with an opening/closing operation of the opening/closing drive mechanism.

2. The machine tool according to claim 1, where the attaching device is a robot or a loader.

3. The machine tool according to claim 2, wherein the robot is provided in the machine tool.

4. The machine tool according to claim 1, wherein the chuck is constituted by
a first sub chuck provided at the rotating device, and
a second sub chuck provided so as to be attachable to and detachable from the first sub chuck,
the second sub chuck is equipped with the swarf cutting tool, and
the attaching device causes the swarf cutting tool to engage with the opening/closing drive mechanism by attaching the second sub chuck to the first sub chuck.

5. The machine tool according to claim 1, wherein the chuck includes a plurality of claws opened or closed according to the opening/closing operation of the opening/closing drive mechanism, and
the attaching device causes the swarf cutting tool to engage with the opening/closing drive mechanism by attaching the cutting tool to the claws.

6. The machine tool according to claim 1, wherein the chuck includes a plurality of detachable claws opened or closed according to the opening/closing operation of the opening/closing drive mechanism, and
the attaching device causes the swarf cutting tool to engage with the opening/closing drive mechanism by detaching the claws from the chuck and attaching the cutting tool.

7. The machine tool according to claim 1, wherein the chuck includes a plurality of claws opened or closed according to the opening/closing operation of the opening/closing drive mechanism, and
the attaching device causes the swarf cutting tool to engage with the opening/closing drive mechanism by causing a part of the cutting tool to engage with the claws while gripping the cutting tool.

8. The machine tool according to claim 5, wherein the cutting tool is constituted by a first cutting tool and a second cutting tool that are paired, and is configured to cut the swarf by performing an opening/closing operation in the same direction as the direction of the opening/closing operation of the opening/closing drive mechanism.

9. The machine tool according to claim 6, wherein the cutting tool is constituted by a first cutting tool and a second cutting tool that are paired, and is configured to cut the swarf by performing an opening/closing operation in the same direction as the direction of the opening/closing operation of the opening/closing drive mechanism.

10. The machine tool according to claim 5, wherein the cutting tool is constituted by a first cutting tool and a second cutting tool that are paired, and is configured to cut the swarf by performing an opening/closing operation in a direction different from the direction of the opening/closing operation of the opening/closing drive mechanism.

11. The machine tool according to claim 6, wherein the cutting tool is constituted by a first cutting tool and a second cutting tool that are paired, and is configured to cut the swarf by performing an opening/closing operation in a direction different from the direction of the opening/closing operation of the opening/closing drive mechanism.

12. The machine tool according to claim 8, wherein the cutting tool cuts the swarf on a rotational axis of the rotating device.

13. The machine tool according to claim 9, wherein the cutting tool cuts the swarf on a rotational axis of the rotating device.

14. The machine tool according to claim 8, wherein the cutting tool cuts the swarf at a position offset by a predetermined distance from a rotational axis of the rotating device.

15. The machine tool according to claim 9, wherein the cutting tool cuts the swarf at a position offset by a predetermined distance from a rotational axis of the rotating device.

16. The machine tool according to claim 1, further comprising a sensor for detecting the swarf entangled with the turning tool,
wherein the attaching device attaches the cutting tool according to a detection signal of the sensor.
